(19) United States
(12) Patent Application Publication
(10) Pub. No.: US 2026/0061762 A1
(43) Pub. Date: Mar. 5, 2026

(54) INKJET PRINTER

(71) Applicant: RISO KAGAKU CORPORATION, Tokyo (JP)

(72) Inventors: Hirohito KUBOTA, Tokyo (JP); Shinichiro OHTSUKA, Tokyo (JP); Naoto TSUJINO, Tokyo (JP); Takashi MAEDA, Tokyo (JP); Yuya SUZUKI, Tokyo (JP); Kento OBUCHI, Tokyo (JP); Naoya KOMINE, Tokyo (JP)

(73) Assignee: RISO KAGAKU CORPORATION, Tokyo (JP)

(21) Appl. No.: 19/254,705

(22) Filed: Jun. 30, 2025

(30) Foreign Application Priority Data
Sep. 4, 2024 (JP) 2024-152367

(51) Int. Cl. B41J 25/308; B41J 11/00

(52) U.S. Cl. CPC B41J 25/3082; B41J 11/007

(57) ABSTRACT

An inkjet printer includes an inkjet head, a conveyor, and abutment mechanisms. The conveyor is arranged below the inkjet head and configured to convey a print medium. The abutment mechanisms include abutment shafts having lower ends configured to abut against the conveyor. The abutment mechanisms are configured to adjust height positions of the abutment shafts individually and steplessly.

### CROSS-REFERENCE TO RELATED APPLICATIONS

The present application is based on and claims the benefit of priority from the prior Japanese Patent Application No. 2024-152367, filed on Sep. 4, 2024, the entire contents of which are incorporated by reference herein.

### TECHNICAL FIELD

The present disclosure relates to an inkjet printer.

### BACKGROUND

The landing accuracy of an ink improves as a head gap, which is the distance between an inkjet head of an inkjet printer and a print medium such as a sheet (e.g. paper), becomes smaller. Therefore, it is possible to obtain excellent image performance. However, collisions or the like between the print medium and the inkjet head are likely to occur, as the head gap becomes smaller. Therefore, the sheet conveyance performance deteriorates.

Meanwhile, the sheet conveyance performance is enhanced as the head gap becomes larger, but the landing accuracy of an ink is likely to deteriorate, and a print surface is likely to be stained by ink mist. Therefore, the image performance deteriorates.

Therefore, it is necessary to adjust a head gap to have a size suitable for printing settings such as the type of a print medium and the print quality to achieve both the image performance and sheet conveyance performance.

JP 2020-82551 A discloses an inkjet recorder having an adjustment mechanism for adjusting the distance between a conveying unit and a head unit in a plurality of steps, as a technique for adjusting a head gap. However, in this technique, since the adjustment is performed in a stepwise manner, the head gap may not be adjusted appropriately.

JP 2021-142740 A discloses a technique which enables adjustment of a head gap in a stepless manner. In this technique, eccentric cams are fixed to one end and the other end of a guide shaft supporting a carriage on which a recording head is disposed. The height of the guide shaft can be adjusted in a stepless manner by rotation of the eccentric cams due to rotation of the guide shaft. This can adjust a head gap, which is the distance between the recording head and a medium supported by a supporting member, in a stepless manner.

### SUMMARY OF THE INVENTION

In the technique disclosed in JP 2021-142740 A, the two eccentric cams fixed to the both ends of the guide shaft are synchronized. Therefore, when there is an inclination of the supporting member relative to the recording head due to variations in dimensional accuracy and assembly accuracy of components, it is not possible to correct the inclination.

If the dimensional accuracy and assembly accuracy of components are high, it is possible to suppress inclination of the supporting member relative to the recording head described above. However, there may be inclination of the supporting member relative to the recording head due to insufficient dimensional accuracy and assembly accuracy of components. In this case, in the technique disclosed in JP 2021-142740 A, it is not possible to correct the inclination as described above. As a result, the head gap may not be adjusted appropriately over the entire printing range.

The present disclosure is directed to an inkjet printer capable of adjusting a head gap appropriately over the entire printing range.

An inkjet printer in accordance with some embodiments includes an inkjet head, a conveyor, and abutment mechanisms. The conveyor is arranged below the inkjet head and configured to convey a print medium. The abutment mechanisms include abutment shafts having lower ends configured to abut against the conveyor. The abutment mechanisms are configured to adjust height positions of the abutment shafts individually and steplessly.

According to the above configuration, the inkjet printer can adjust the head gap appropriately over the entire printing range.

### BRIEF DESCRIPTION OF DRAWINGS

FIG. 1 is a schematic configuration diagram of an inkjet printer according to an embodiment.

FIG. 2 is a control block diagram of the inkjet printer illustrated in FIG. 1.

FIG. 3 is a perspective view illustrating a schematic configuration of a printing unit of the inkjet printer illustrated in FIG. 1.

FIG. 4 is a perspective view illustrating a schematic configuration of an abutment mechanism of the inkjet printer illustrated in FIG. 1.

FIG. 5 is a diagram for explaining an operation of adjusting the distance between a head and a conveying surface.

FIG. 6 is a diagram illustrating an example in which an abutment shaft of an abutment mechanism and an abutment shaft of another abutment mechanism are arranged at different height positions.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

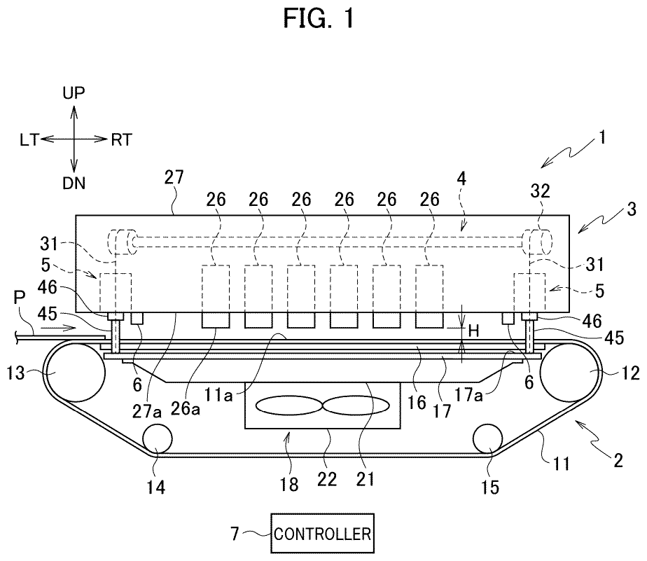

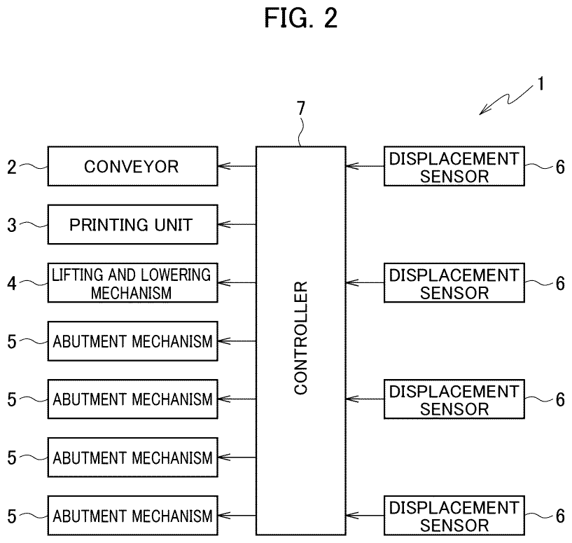

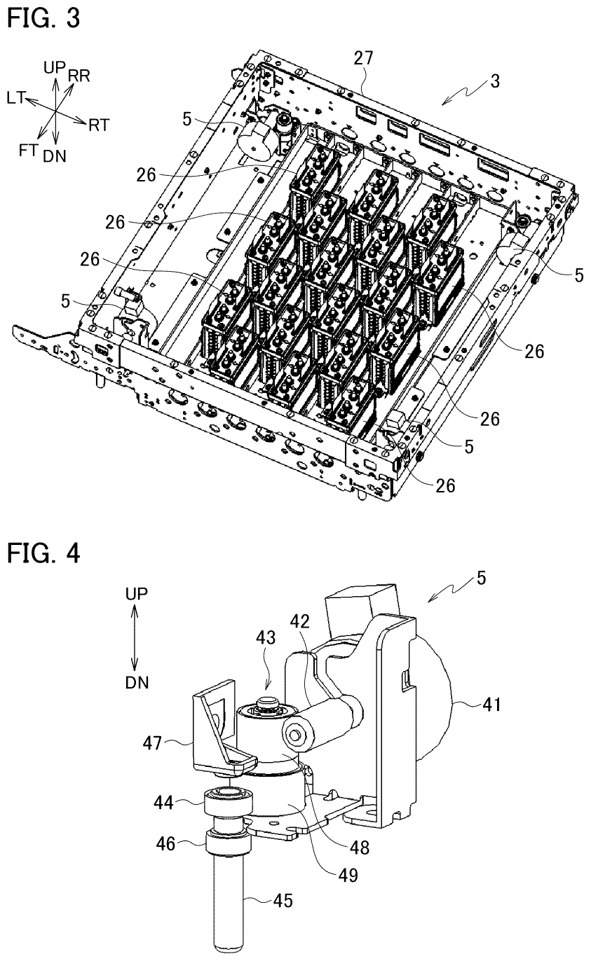

FIG. 1 is a schematic configuration diagram of an inkjet printer 1 according to an embodiment of the present invention. FIG. 2 is a control block diagram of the inkjet printer 1 illustrated in FIG. 1. FIG. 3 is a perspective view illustrating a schematic configuration of a printing unit 3 of the inkjet printer 1 illustrated in FIG. 1. FIG. 4 is a perspective view illustrating a schematic configuration of an abutment mechanism 5 of the inkjet printer 1 illustrated in FIG. 1. In the following description, a direction orthogonal to the page space of FIG. 1 is defined as a front-rear direction. Further, up-down and left-right sides of the page space of FIG. 1 are defined as up-down and left-right directions. In FIGS. 1, 3, and 4, a right direction, a left direction, an up direction, a down direction, a front direction, and a rear direction are represented by RT, LT, UP, DN, FT, and RR, respectively.

As illustrated in FIGS. 1 and 2, the inkjet printer 1 includes a conveyor 2, the printing unit 3, a lifting and lowering mechanism 4, four abutment mechanisms 5, four displacement sensors 6, and a controller 7.

The conveyor 2 conveys a sheet (e.g. paper) P which is a print medium fed from a sheet feeder (not illustrated). The conveyor 2 is arranged below the printing unit 3. The conveyor 2 includes a conveying belt 11, a driving roller 12, driven rollers 13 to 15, a platen 16, a platen plate 17, and a suction unit 18.

The conveying belt 11 sucks and holds the sheet P conveyed from the sheet feeder and conveys the sheet P. The conveying belt 11 is an annular belt which is extended around the driving roller 12, and the driven rollers 13 to 15. The conveying belt 11 has therein a large number of belt holes (not illustrated) which are through holes for air suction. The conveying belt 11 sucks and holds the sheet P on a conveying surface 11a by the suction force generated in the belt holes by driving a fan 22 of the suction unit 18 described later. The conveying surface 11a is a surface on which the sheet P of the conveying belt 11 is placed, and is an upper surface of a planar portion of the conveying belt 11 extended between the driving roller 12 and the driven roller 13. The conveying belt 11 rotates in a clockwise direction (endless movement) in FIG. 1 to convey the sucked and held sheet P in a conveying direction from left to right.

The driving roller 12 rotates the conveying belt 11. The driving roller 12 is rotated and driven by a motor (not illustrated).

The driven rollers 13 to 15 support the conveying belt 11 together with the driving roller 12. The driven rollers 13 to 15 rotate in a driven manner following the conveying belt 11. The driven roller 13 has the same height as the driving roller 12 and is arranged on the left side of the driving roller 12. The driven rollers 14 and 15 are arranged below the driving roller 12 and the driven roller 13. The driven rollers 14 and 15 are separated from each other in a left-right direction and have the same height.

The platen 16 is interposed between the driving roller 12 and the driven roller 13, and is arranged below the conveying belt 11. The platen 16 is a planar plate-like member for supporting the conveying belt 11 in a slidable manner. The platen 16 is rectangular in plan view. The platen 16 has therein a plurality of through holes which allow air sucked by the fan 22 to pass therethrough.

The platen plate 17 is a planar plate-like member which is arranged below the platen 16 and supports the platen 16 through a plurality of spacers (not illustrated). The platen plate 17 is rectangular in plan view. The platen plate 17 has therein a plurality of through holes which allow air sucked by the fan 22 to pass therethrough. An upper surface of the platen plate 17 is an abutment surface 17a against which a distal end (lower end) of an abutment shaft 45 of the abutment mechanism 5 described later abuts. The platen plate 17 is formed to be larger than the conveying belt 11 and the platen 16 in the front-rear direction.

The suction unit 18 sucks air through the through holes formed in the platen plate 17, the through holes formed in the platen 16, and the belt holes formed in the conveying belt 11, and sucks the sheet P to the conveying belt 11. The suction unit 18 includes a chamber 21 and the fan 22.

The chamber 21 forms a negative pressure chamber for generating the suction force in the belt holes formed in the conveying belt 11. The chamber 21 is disposed on the back side of the platen plate 17.

The fan 22 exhausts the air from the chamber 21. As a result, the fan 22 sucks the air through the through holes formed in the platen plate 17, the through holes formed in the platen 16, and the belt holes formed in the conveying belt 11, the fan 22 generates the suction force in the belt holes, and the fan 22 sucks the sheet P to the conveying belt 11.

The printing unit 3 performs printing on the sheet P conveyed by the conveyor 2. As illustrated in FIGS. 1 and 3, the printing unit 3 includes a plurality of inkjet heads 26 and a head holder 27.

The inkjet heads 26 eject inks on the sheet P. The inkjet heads 26 have a plurality of nozzles (not illustrated) opened to nozzle surfaces 26a, which are lower surfaces facing the conveying surface 11a of the conveying belt 11, and the inkjet heads 26 eject inks from the nozzles. In the present embodiment, eighteen inkjet heads 26 are arranged in a staggered shape.

The head holder 27 holds the inkjet heads 26. The head holder 27 holds the inkjet heads 26 by projecting lower ends of the inkjet heads 26 downward from a lower surface 27a of the head holder 27. The head holder 27 is rectangular in plan view.

The lifting and lowering mechanism 4 lifts and lowers the conveyor 2. The lifting and lowering mechanism 4 includes a wire 31 and a winding mechanism 32.

Each wire 31 suspends and supports the conveyor 2. Each wire 31 is inserted through a through hole formed in the abutment shaft 45 of each abutment mechanism 5, and a distal end (lower end) thereof is connected to the platen plate 17.

The winding mechanism 32 lifts and lowers the conveyor 2 by winding and delivering the wire 31.

The abutment mechanism 5 defines a distance H between the head and the conveying surface. The distance H between the head and the conveying surface is the distance between the nozzle surfaces 26a of the inkjet heads 26 and the conveying surface 11a of the conveying belt 11. In other words, the distance H between the head and the conveying surfaces is obtained by adding the thickness of the sheet P to a head gap, which is the distance between the nozzle surfaces 26a and the sheet P on the conveying surface 11a.

As illustrated in FIG. 3, each of four corners of the head holder 27 has one abutment mechanism 5.

As illustrated in FIG. 4, the abutment mechanism 5 includes an abutment motor (driver) 41, a worm (worm gear) 42, an intermediate gear 43, an abutment gear 44, the abutment shaft 45, a nut 46, and a reference block 47.

The abutment motor 41 rotates the abutment shaft 45 through the worm 42, the intermediate gear 43, and the abutment gear 44, and changes the height position of the abutment shaft 45. The abutment shaft 45 is lowered by forward rotation driving of the abutment motor 41, and the abutment shaft 45 is lifted by reverse rotation driving of the abutment motor 41. The abutment motor 41 includes a pulse motor, for example.

The worm 42 transmits the driving force of the abutment motor 41 to the intermediate gear 43. The worm 42 is fixed to an output shaft of the abutment motor 41.

The intermediate gear 43 transmits the driving force of the abutment motor 41 from the worm 42 to the abutment gear 44. The intermediate gear 43 is constituted by a two-stage gear including a worm wheel 48 meshing with the worm 42, and a lower gear 49 with spur gears meshing with the abutment gear 44.

The abutment gear 44 rotates together with the abutment shaft 45 by means of the driving force of the abutment motor 41 transmitted from the intermediate gear 43. The abutment gear 44 is integrally formed with the abutment shaft 45 to surround the periphery of an upper end of the abutment shaft 45. The abutment gear 44 has spur gears meshing with the lower gear 49.

The abutment shaft 45 is a member of which a lower end abuts against the conveyor 2. Specifically, the lower end of the abutment shaft 45 abuts against the abutment surface 17a of the platen plate 17. The abutment shaft 45 is formed by a screw and is screwed to the nut 46. This changes the height position of the abutment shaft 45 rotated by driving of the abutment motor 41. Therefore, the distance H between the head and the conveying surface can be changed, when the lower end of the abutment shaft 45 abuts against the conveyor 2.

A through hole is formed in the abutment shaft 45 in an axial direction thereof, and the wire 31 is inserted through the through hole.

The height position of the abutment shaft 45 of each abutment mechanism 5 can be adjusted steplessly by driving each abutment motor 41. The abutment shaft 45 moves up and down by a movement amount corresponding to the number of driving pulses of the abutment motor 41. However, the movement amount of the abutment shaft 45 for one pulse of the driving pulses is very small, to the extent that the height position of the abutment shaft 45 can be considered to be adjustable steplessly.

The nut 46 is used for changing the height position of the rotating abutment shaft 45. The nut 46 is fixed to the lower surface 27a of the head holder 27.

The reference block 47 defines a reference height position of the abutment shaft 45. The upper end of the abutment shaft 45 abuts against the reference block 47, and the abutment shaft 45 stops. As a result, the abutment shaft 45 is arranged at the reference height position.

The displacement sensor 6 is arranged in the vicinity of the abutment mechanism 5 on the lower surface 27a of the head holder 27. The displacement sensor 6 detects the distance from the displacement sensor 6 to the abutment surface 17a of the platen plate 17. Each of the four abutment mechanisms 5 has one displacement sensor 6 in the vicinity thereof.

The controller 7 controls the operation of each unit of the inkjet printer 1. The controller 7 includes a CPU, RAM, ROM, hard disk, and the like.

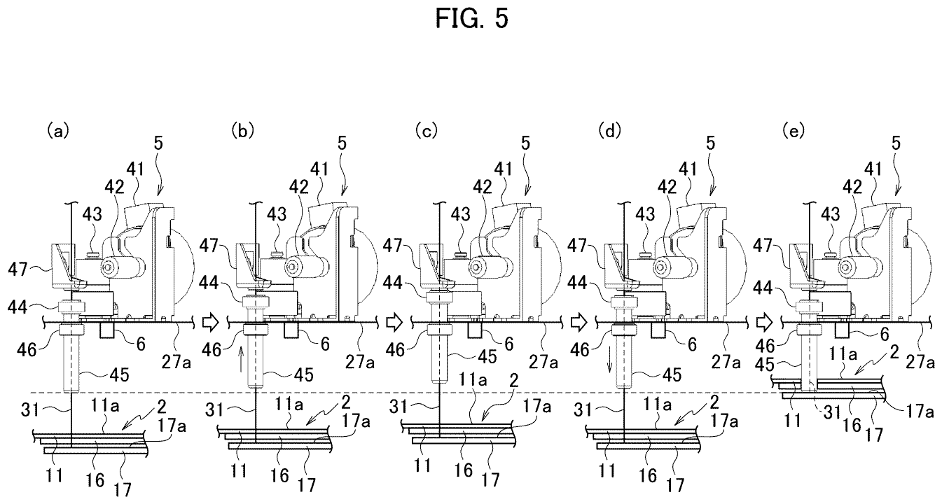

Next, with reference to FIG. 5, a description will be given regarding the operation of adjusting the distance H between the head and the conveying surface in the inkjet printer 1.

Part (a) of FIG. 5 shows a state in which the height position of the abutment shaft 45 of each abutment mechanism 5 is not clear, when the power of the inkjet printer 1 is turned on. In the state, the conveyor 2 is disposed below the lower end of the abutment shaft 45.

From the state shown in part (a) of FIG. 5, the controller 7 performs reverse rotation driving of the abutment motor 41 of each abutment mechanism 5, and lifts the abutment shaft 45 as shown in part (b) of FIG. 5.

At this time, the controller 7 performs reverse rotation driving of the abutment motor 41 for a prescribed time. As a result, as shown in part (c) of FIG. 5, the abutment shaft 45 abuts against the reference block 47, step-out of the abutment motor 41 occurs, and the abutment shaft 45 stops at the reference height position.

Next, the controller 7 performs forward rotation driving of the abutment motor 41 of each abutment mechanism 5, and lowers the abutment shaft 45 as shown in part (d) of FIG. 5. At this time, the controller 7 performs forward rotation driving of the abutment motor 41 by the number of driving pulses for lowering the abutment shaft 45 to a target height position. As a result, the abutment shaft 45 of each abutment mechanism 5 is lowered to the target height position.

The target height position of the a abutment shaft 45 is a height position at which the distance H between the head and the conveying surface has a target value. The number of driving pulses described above includes a correction value of the number of driving pulses which will be described later.

Next, the controller 7 causes the lifting and lowering mechanism 4 to lift the conveyor 2, and causes the abutment shaft 45 to abut against the platen plate 17. As a result, the distance H between the head and the conveying surface has a target value, and adjustment of the distance H between the head and the conveying surface ends.

In the inkjet printer 1, a sheet conveyance performance priority mode and an image performance priority mode are selectable as printing modes. The printing modes can be selected by a user operating an operation input unit (not illustrated), for example.

The sheet conveyance performance priority mode is a printing mode in which higher priority is given to sheet conveyance performance rather than to image performance. The image performance priority mode is a printing mode in which higher priority is given to image performance rather than to sheet conveyance performance. Sheet conveyance performance indicates the difficulty of occurrence of conveyance failure such as collision between the sheet P and the inkjet heads 26. Image performance indicates the print quality. Sheet conveyance performance is enhanced as the head gap becomes larger, and the image performance is enhanced as the head gap becomes smaller.

The thicker the sheet P, the smaller the head gap, even if the distance H between the head and the conveying surface is the same.

Therefore, as the target value of the above-described distance H between the head and the conveying surface, a value according to the sheet type (sheet thickness) and printing mode is set. Therefore, in the inkjet printer 1, the head gap can be adjusted according to a sheet type and a printing mode.

Next, correction values of the number of driving pulses of the abutment motor 41 described above will be described.

There may be variations in a reference height position of the abutment shaft 45 of each abutment mechanism 5 due to variations in dimensional accuracy and assembly accuracy of components related to the distance H between the head and the conveying surface in the head holder 27, the conveyor 2, the abutment mechanism 5, and the like of the inkjet printer 1.

Therefore, even if the abutment shaft 45 of each abutment mechanism 5 abuts against the reference block 47, and then is lowered by the same number of driving pulses corresponding to a target height position, a height position of the abutment shaft 45 may deviate from the target height position. Therefore, when the abutment shaft 45 of each abutment mechanism 5 abuts against the conveyor 2, there is a possibility that the conveying surface 11a is inclined, and the head gap may not be adjusted appropriately over the entire printing range.

Therefore, in the inkjet printer 1, correction values of the number of driving pulses of the abutment motor 41 are calculated for correcting the height position of the abutment shaft 45.

Specifically, when the inkjet printer 1 is started for the first time, the controller 7 lifts the abutment shaft 45 of each abutment mechanism 5 from the state shown in part (a) of FIG. 5 to the state shown in part (b) of FIG. 5, and stops the abutment shaft 45 at a reference height position as shown in part (c) of FIG. 5, for example.

Next, the controller 7 causes the lifting and lowering mechanism 4 to lift the conveyor 2, and causes the abutment shaft 45 to abut against the platen plate 17.

Next, the controller 7 acquires, from each displacement sensor 6, the distance between the displacement sensor 6 and the abutment surface 17a of the platen plate 17.

Next, the controller 7 calculates the difference value between the distance obtained from each displacement sensor 6, and a theoretical value of the distance between the displacement sensor 6 and the abutment surface 17a, when the abutment shaft 45 arranged at the reference height position abuts against the platen plate 17. The difference value indicates the amount of deviation of the reference height position of the abutment shaft 45 from the theoretical value thereof. The difference value becomes a positive value, when the reference height position of the abutment shaft 45 deviates downward relative to a design position, and alternatively the difference value becomes a negative value, when the reference height position deviates upward.

Next, the controller 7 calculates the number of driving pulses for moving the abutment shaft 45 by the magnitude of the difference value corresponding to each displacement sensor 6.

Then, for each displacement sensor 6, the controller 7 calculates a value in which the calculated number of driving pulses has a sign opposite to a sign of the difference value, as a correction value for the number of driving pulses of the abutment motor 41 of each abutment mechanism 5 in the vicinity of the displacement sensor 6.

The correction value for the number of driving pulses of the abutment motor 41 of each abutment mechanism 5 calculated in this way is used for an operation of adjusting the distance H between the head and the conveying surfaces described above.

That is, when the abutment shaft 45 is lowered from the reference height position, the controller 7 performs forward rotation driving of the abutment motor 41 by the number of driving pulses, which is obtained by adding the correction value described above to a theoretical value of the number of driving pulses for lowering the abutment shaft 45 to the target height position. As a result, even if there are variations in the reference height position of the abutment shaft 45 of each abutment mechanism 5, the height position of the abutment shaft 45 of each abutment mechanism 5 can be aligned, and the inclination of the conveying surface 11a can be suppressed. Accordingly, the head gap can be adjusted appropriately over the entire printing range of the sheet P.

In the inkjet printer 1, it may be desired to arrange the abutment shaft 45 of each abutment mechanism 5 at a specific height position.

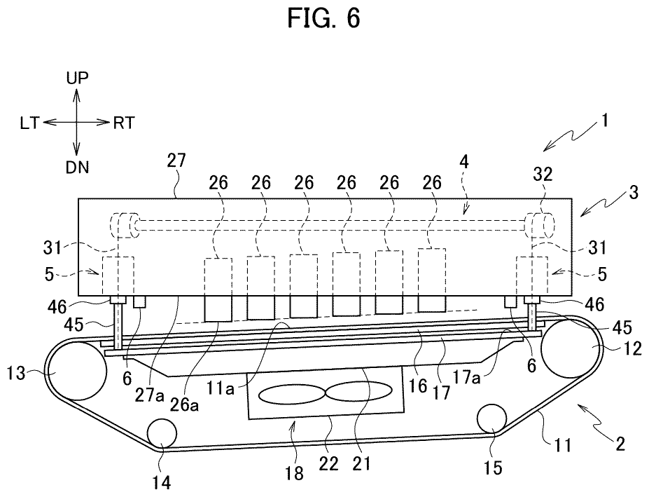

Suppose that, as illustrated in FIG. 6, the projection amounts of the inkjet heads 26 from the head holder 27 increase in an ascending order from right to left, due to an error or the like in a height position at which each inkjet head 26 is attached to the head holder 27, and the height position of the plurality of inkjet heads 26 of the printing unit 3 is inclined, for example. In the above case, if the conveying surface 11a is horizontal, the conveying surface 11a is inclined relative to the arrangement of the plurality of inkjet heads 26 of the printing unit 3 in the height direction.

Therefore, in this case, the controller 7 adjusts the height position of the abutment shaft 45 of each abutment mechanism 5, such that abutment shafts 45 of abutment mechanisms 5 located at two corners on the left side are arranged at lower positions than abutment shafts 45 of abutment mechanisms 5 located at two corners on the right side, and such that the distance H between the head and the conveying surface at the position of each inkjet head 26 is substantially uniform. This can correct the inclination of the conveying surface 11a relative to the plurality of inkjet heads 26 of the printing unit 3. Therefore, the head gap can be adjusted appropriately over the entire printing range of the sheet P.

As described above, the inkjet printer 1 includes the four abutment mechanisms 5, each of which has the abutment shaft 45 of which the lower end abuts against the conveyor 2, and can adjust the height position of the abutment shaft 45 steplessly. Since the height position of the abutment shaft 45 can be adjusted steplessly, the distance H between the head and the conveying surface can be adjusted steplessly. Since the height positions of the abutment shafts 45 of the four abutment mechanisms 5 can be individually adjusted, inclination of the conveying surface 11a can be suppressed, even if there are variations in the dimensional accuracy and assembly accuracy of components related to the distance H between the head and the conveying surface. This can also support a case where it is desired to arrange the abutment shaft 45 of each abutment mechanism 5 at a specific height position. Therefore, according to the inkjet printer 1, it is possible to adjust the head gap appropriately over the entire printing range of the sheet P.

Each abutment shaft 45 of the inkjet printer 1 is formed by a screw. Each abutment mechanism 5 has the nut 46 which is arranged on the lower surface 27a of the head holder 27 and to which each abutment shaft 45 is screwed, and the abutment motor 41 which rotates each abutment shaft 45 and changes the height position of each abutment shaft 45. As a result, it is possible to adjust the height position of each abutment shaft 45 steplessly.

In the above-described embodiment, it is assumed that the displacement sensor 6 detects the distance to the abutment surface 17a. However, the displacement sensor 6 may also detect the distance to the conveying surface 11a. In this case, a correction value of the number of driving pulses of the abutment motor 41 can be calculated using the difference value between the distance detected by the displacement sensor 6, and a theoretical value of the distance between the displacement sensor 6 and the conveying surface 11a.

The displacement sensor 6 may be omitted. In this case, when the inkjet printer 1 is assembled, the reference height position of the abutment shaft 45 of each abutment mechanism 5 is measured with high accuracy, and a correction value of the number of driving pulses of the abutment motor 41 of each abutment mechanism 5 is calculated based on the measurement result, for example. In the operation of adjusting the distance H between the head and the conveying surface, when the abutment shaft 45 of each abutment mechanism 5 is lowered from a reference height position, it is sufficient if the controller performs forward rotation driving of the abutment motor 41 by the number of driving pulses, which is obtained by adding the above-described correction value, to a theoretical value of the number of driving pulses for lowering the abutment shaft 45 to the target height position.

In the above-described embodiment, the inkjet printer has the four abutment mechanisms 5. However, the number of abutment mechanisms is not limited to four, and it is sufficient if the inkjet printer has a configuration in which the distance between the head and conveying surface is adjusted by abutment shafts 45 of a plurality of abutment mechanisms 5.

The embodiment of the present disclosure has the following configuration, for example.

An inkjet printer includes an inkjet head, a conveyor, and abutment mechanisms. The conveyor is arranged below the inkjet head and configured to convey a print medium. The abutment mechanisms include abutment shafts having lower ends configured to abut against the conveyor. The abutment mechanisms are configured to adjust height positions of the abutment shafts individually and steplessly.

The inkjet printer above may further include a head holder configured to hold the inkjet head. Each of the abutment shafts may include a screw, and each of the abutment mechanisms may include: a nut which is arranged on a lower surface of the head holder and to which the abutment shaft is screwed; and a driver configured to rotate the abutment shaft and change a height position of the abutment shaft.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

1. An inkjet printer comprising:
an inkjet head;
a conveyor arranged below the inkjet head and configured to convey a print medium; and
abutment mechanisms including abutment shafts having lower ends configured to abut against the conveyor, the abutment mechanisms configured to adjust height positions of the abutment shafts individually and steplessly.

2. The inkjet printer according to claim 1, further comprising a head holder configured to hold the inkjet head, wherein
each of the abutment shafts includes a screw, and
each of the abutment mechanisms includes:
a nut which is arranged on a lower surface of the head holder and to which the abutment shaft is screwed; and
a driver configured to rotate the abutment shaft and change a height position of the abutment shaft.
